(19) United States
(12) Patent Application Publication
(10) Pub. No.: US 2017/0211626 A1
(43) Pub. Date: Jul. 27, 2017

(54) SURFACE TREATED BEARING COMPONENT

(71) Applicant: NSK Americas, Inc., Ann Arbor, MI (US)

(72) Inventors: Anderson Ferreira Da Silva, Suzano (BR); Marcos Vilodres Campanha, Sao Paulo (BR)

(21) Appl. No.: 15/326,242

(22) PCT Filed: Jul. 16, 2015
(86) PCT No.: PCT/US2015/040680

§ 371 Date: Jan. 13, 2017

Related U.S. Application Data
(60) Provisional application No. 62/025,200, filed on Jul. 16, 2014.
(60) Provisional application No. 62/025,182, filed on Jul. 16, 2014.

(51) Int. Cl. F16C 33/62; F16C 33/66; C21D 1/09; B23K 26/00; C21D 9/40; F16C 33/58; B23K 26/08

(52) U.S. Cl. CPC F16C 33/62; F16C 33/585; F16C 33/6696; B23K 26/0823; B23K 26/0066; C21D 9/40; C21D 1/09; F16C 2202/52; F16C 2223/10

(57) ABSTRACT

A surface treated bearing component and a bearing (10) including such bearing component. The bearing component may include a peripheral surface adapted for contacting a rolling body (16). A mass adjoins the surface. The surface has a plurality of visible overlapping striped regions (26, 28) generally devoid of any surface erosion. The surface may have a graphitic layer (36) formed in situ thereon. The mass portion may include a first region (30) having a depth (e.g., of about 50 to about 200 micrometers) and a first carbon content. The mass may include a second region (32) generally adjoining the first region having a depth (e.g., about 50 to about 100 micrometers) and a second carbon content less than the carbon content of the first region. A third region (34) generally adjoins the second region and has a third carbon content less than the carbon content of the first and the second region. The third region generally will have the composition and microstructure of the bulk bearing component as it existed before any surface treatment.

### CLAIM OF BENEFIT OF FILING DATE AND PRIORITY

The present application claims the benefit of the filing date of, and priority to, U.S. Application No. 62/025,182, filed Jul. 16, 2014, which is hereby incorporated by reference in its entirety, and U.S. Application No. 62/025,200, filed Jul. 16, 2014, which is hereby incorporated by reference in its entirety.

### FIELD

In general, the present teachings relate to improved bearings, and particularly to rolling bearings that are surface treated to exhibit improved surface lubricity, wear, or both.

### BACKGROUND

Notwithstanding efforts over the years to improve bearing life and/or reduce the coefficient of friction of bearing surfaces, there still remains a need for additional bearing structures that exhibit one or both of the foregoing.

The ability to reduce friction by surface treatment of bearing steel has been the subject of a paper delivered by A. F. da Silva et al., “Reduction Of Friction Promoted By Surface Treatment By CO₂ Laser In AISI 52100 Steel” (delivered at First International Brazilian Conference on Tribology TriboBr, Nov. 24-26, 2010, Rio de Janeiro RJ Brazil), incorporated by reference.

The following U.S. patent documents may be related to the present teachings: U.S. Pat. Nos. 5,529,646; 5,725,807; 5,861,067; 5,879,480; 6,309,475; 6,350,326; 6,655,845; 7,063,755, 7,687,112; 8,454,241; and 8,485,730, all of which are incorporated by reference herein for all purposes.

### SUMMARY

The present teachings make use of a simple, yet elegant, approach to the construction of an improved bearing, and particularly a rolling bearing that includes an inner ring, and outer ring, and at least one rolling body (e.g., a plurality of circumferentially spaced balls) disposed between the inner and outer ring so that the inner ring and outer ring can rotate relative to each other about a rotational axis. The inner ring, the outer ring, or both, of the bearing desirably has a treated surface (e.g., an outer peripheral surface of an inner ring, and/or an inner peripheral surface of an outer ring) for engaging the at least one rolling body. The treated surface is treated such that it initially has a thin graphitic layer formed thereon in situ (such as during the surface treatment process), and has a carbon and hardness gradient that penetrates from the surface to a desired depth into an adjoining mass of the ring. In general, there may be discrete regions that result (in some instances to the naked eye, but typically by examination of a cross section using an optical microscope at a magnification of 100× or more). In this manner, lubricity for the rolling body is imparted, as well as a hardness profile that affords the potential for improved bearing wear life.

In accordance with the present teachings there is thus contemplated a bearing component, as well as a bearing including such bearing component. The bearing component may include a surface adapted for contacting a rolling body. A mass adjoins (and terminates radially) at the surface. The surface is characterized by a plurality of visible overlapping striped regions that are generally devoid of any surface erosion. The surface may have a graphitic layer thereon, namely a graphitic layer formed in situ during a surface treatment. The mass may include a first region having a depth of about 50 to about 200 micrometers and having a first carbon content. The mass may include a second region beneath and generally adjoining the first region having a depth of about 50 to about 100 micrometers and having a second carbon content that is less than the carbon content of the first region. The mass may include a third region beneath and generally adjoining the second region having a third carbon content that is less than the carbon content of the first and the second region. The mass of the third region generally will have the composition and microstructure of the bulk bearing component as it existed before any surface treatment. Progressing from the surface into the third region, there will be a hardness gradient that generally corresponds with the level of carbon content; that is, the higher the carbon content, the higher the hardness, and the lower the carbon content, the lower the hardness. Thus, progressing from the surface to the third region, there is a generally continuous decrease in the amount of carbon and the hardness, until a generally constant amount of carbon and hardness is realized in the third region.

For steel bearings, the increased hardness present toward the surface may be attributable at least in part to an increase in the amount of a martensitic phase that is formed due to the treatment conditions and carbon content. The surface may exhibit an absence of any evidence of ablation and/or cracks when viewed under an optical microscope at a magnification of 100× after being subjected to dynamic loading of about 10.8 Newtons (N) applied in the radial direction, for at least about 6.5 million revolutions of the bearing, at least about 25 million revolutions of the bearing, at least about 100 million revolutions of the bearing, or even at least about 250 million revolutions of the bearing. For example, it may be possible that cracks are not visible under an optical microscope at a magnification of 100× until more than 400 million revolutions under such load have occurred (e.g., a bearing may survive about 430 million revolutions at such load).

The present teachings provide a number of technical benefits. including but not limited to a treated bearing (or component thereof) that can be self-lubricating, a treated bearing (or component thereof) that has a longer wear life as compared with an untreated bearing, a treated bearing surface that has a reduced coefficient of friction as compared with an untreated bearing surface (e.g., a reduction as compared with an untreated bearing of at least about 30%, 50%, or even 70%), or any combination of the foregoing.

### BRIEF DESCRIPTION OF THE DRAWINGS

FIG. 1 is a perspective partial cutaway view of an example of a rolling bearing in accordance with the present teachings,

FIG. 2 is a magnified plan view of a treated bearing component surface in accordance with the present teachings illustrating a striped pattern.

FIG. 3 is an optical micrograph (at 100×) of a cross-section of an illustrative bearing component in accordance with the present teachings, illustrating adjoining overlapping regions.

FIG. 4 is an optical micrograph (at 100×) of a longitudinal section of an illustrative bearing component in accordance with the present teachings, in which discrete visible regions are shown in accordance with depth from the bearing surface is shown.

FIG. 5 is an optical micrograph (at 200×) of a cross-section of an illustrative bearing component in accordance with the present teachings, illustrating adjoining overlapping regions.

FIG. 6 is an illustrative hardness profile for one example of a bearing component in accordance with the present teachings.

### DETAILED DESCRIPTION

As required, detailed embodiments of the present teachings are disclosed herein; however, it is to be understood that the disclosed embodiments are merely exemplary of the teachings that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present teachings.

In general, and as will be appreciated from the description that follows, the present teachings pertain to a simple, yet elegant, approach to the construction of an improved bearing, and particularly a rolling bearing that includes an inner ring, and outer ring, and at least one rolling body (e.g., a plurality of circumferentially spaced balls) disposed between the inner and outer ring so that the inner ring and outer ring can rotate relative to each other about a rotational axis. The inner ring, the outer ring, or both. of the bearing desirably has a treated surface (e.g., an outer peripheral surface of an inner ring, and/or an inner peripheral surface of an outer ring) for engaging the at least one rolling body. The treated surface is treated such that it initially has a thin graphitic layer formed thereon, formed in situ from the surface treatment, and has a carbon and hardness gradient that penetrates from the surface to a desired depth into an adjoining mass portion of the ring. In general, there may be discrete regions that result (in some instances to the naked eye, but typically by examination a cross section using an optical microscope at a magnification of 100× or more). In this manner, lubricity for the rolling body is imparted, as well as a hardness profile that affords the potential for improved bearing wear life.

In accordance with the present teachings there is thus contemplated a bearing component, as well as a bearing including such bearing component. The bearing component may include a metal mass that is configured to define a metal surface adapted for contacting a rolling body. The surface is characterized by a plurality of visible overlapping striped regions that are generally devoid of any surface erosion (e.g., by inspection using an optical microscope at a magnification of 100×). The surface may have a graphitic layer thereon. The metal mass may include a first region having a depth (e.g., of about 50 to about 200 micrometers) and having a first carbon content. The mass may include a second region beneath and generally adjoining (e.g., directly) the first region having a depth (e.g., of about 50 to about 100 micrometers) and having a second carbon content that is less than the carbon content of the first region. The mass may include a third region beneath and generally adjoining (e.g., directly) the second region having a third carbon content that is less than the carbon content of the first and the second region. The mass of the third region generally will have the composition and microstructure of the bulk bearing component as it existed before any surface treatment. Progressing from the surface into the third region, there will be a hardness gradient that generally corresponds with the level of carbon content; that is, the higher the carbon content, the higher the hardness, and the lower the carbon content the lower the hardness. For steel bearings, the hardness may be attributable at least in part to an increase in the amount of a martensitic phase that is formed due to the treatment conditions and carbon content.

The bearing component may exhibit certain other physical appearances or characteristics that allow the respective regions to be distinguished relative to one another. This may be determined metallographically. For example, the first region may be distinguishable from the second region by a visible color change upon etching (e.g., by way of etching in accordance with ASTM E407-07e1, such as by using a picral etch, a nital etch or the like). The third region may be distinguishable from the second region and the first region by the presence in the third region of a generally constant hardness, and a generally constant carbon content (e.g., an average content that fluctuates in the third region between a maximum and minimum content by an amount below about 15%, 10% or even 5% of the average content). Microstructure may also vary in a manner to render it possible to ascertain the different regions. For instance, the first region may have a higher average content of martensite relative to the average content (by volume) of martensite in the second and third regions, The second region may have an average content of martensite below that of the first region and higher than that of the third region. The third region may have a generally constant content of martensite (e.g., an average content that fluctuates in the third region between a maximum and minimum content by an amount below about 15%, 10%, or even 5% of the average content). The third region may also be characterized has having a generally uniform presence of martensite and austenite phases. The boundary between regions may also be determined (or confirmed (based upon metallographic inspection)) by x-ray diffraction techniques for identifying the presence of different peaks (which correspond with different phases) across a section of the bearing component. For example, the third region may have an x-ray diffraction (XRD) pattern that is generally characteristic of the starting bearing material. The second region, in turn, may show phases from the third region, with the addition of peaks corresponding to the presence of additional elements or phases. For example, the second region may exhibit a more intense peak corresponding with carbon than any carbon corresponding peak in the third region. In addition, or in the alternative, the second region may exhibit the presence of a more pronounced peak (believed to correspond with α (110)) at a 2θ value of about 75° than that of the third region. As well, there may be noticed the presence of a relatively pronounced peak at a 2θ value of about 26° than that of the third region. The first region is expected to exhibit a plurality of relatively pronounced peaks corresponding with the presence of carbon than found in the second and third regions.

Desirably the surface is configured as a rolling surface of an outer bearing ring, or a rolling surface of an inner bearing ring. As can be appreciated, the bearing components herein may be annular in shape. The rolling body may include a ball, cylinder, or a pin. The bearing component thus may be generally annular. The surface may initially include a layer of graphite at least partially coated thereon. For example, it is envisioned that a layer of graphite formed may have a thickness of about 0.1 to about 10 μm, or about 1 to about 7 μm, or even about 2 to about 5 μm (e.g., about 3 μm). This layer of graphite is formed in-situ during the surface treatment to form the present bearing components, and is not subsequently applied.

From an appearance standpoint, there will be a visible pattern, such as a plurality of visible stripes (either to the naked eye or under magnification by an optical microscope (e.g., at about 100× magnification)). More particularly, there may be visible stripes that include a plurality of visible overlapping striped regions and/or include at least one helical stripe having a generally continuous width that circumscribes the bearing component which may overlap an adjoining stripe in an amount of about 5 to about 80 percent (e.g., about 10 to about 60 percent) of the width of an adjoining stripe. For example, the plurality of visible overlapping striped regions may include at least one helical stripe and the at least one helical stripe has a width in the range of about 108 to about 500 micrometers. Further from an appearance standpoint, a side sectional view of a bearing component, under an optical microscope (e.g., at a magnification of 100×), may have an appearance of a successive repeating pattern extending along the rotational axis of the bearing component. The repeating pattern may have a region that appears brighter toward the surface of the bearing component, and that has an arcuate boundary with a darker region below it.

The first region of the bearing component, namely the region of the bearing component that extends from the surface to a first depth into the mass of the bearing component, may have a hardness (Vickers Hardness, measured in accordance with ASTM E384-11e1) in the range of about 850 to about 1150 HV_{0.3}. The second region, namely the region that directly adjoins the first region and extends to a second depth into the mass of the bearing component, has a hardness (Vickers Hardness, measured in accordance with ASTM E384-11 e1) in the range of about 700 to about 850 HV_{0.2}. As can be appreciated, there will generally be a slight decrease in hardness as the first region transitions into the second region. The third region will directly adjoin the second region and will extend into the remainder of the mass of the bearing component. The third region typically will have approximately the same hardness of the bulk bearing component in its initial untreated state, and will exhibit a generally constant hardness profile. For example, it may be in the range of about 560 to about 700 HV_{0.3}. Thus, progressing from the surface to the third region there is a generally continuous decrease in the amount of carbon and the hardness, until a generally constant amount of carbon and hardness is realized in the third region.

The average carbon content (as determined by EDS) of the first region may be from about 5 to about 40 (e.g., about 10 to about 25) percent higher than the average carbon content of the third region. The average carbon content of the second region may be lower than that of the first region, but higher than that of the third region (e.g., from about 1 to about 20 (e.g., about 3 to about 10) percent higher than the carbon content of the third region. There may be a progressively decreasing amount of carbon moving from the surface of the first region to the third region. Thus, in the first and second regions, there may be a carbon gradient. Within the third region, there will generally be a constant carbon content. In general, the bearing component may be made of steel, such as a stainless steel, which may be (by way of example) AISI 52100 steel, SUJ2 steel, or SUJ3 steel, By way of illustration, the bearing component thus may be a steel that, in at least the third region of the component, has a composition that includes carbon in an amount of about 0.7% to about 1.2% by weight carbon of the overall steel (e.g., about 0.85% to about 1.10% by weight of the overall steel). It may include chromium in an amount of about 0.8% to about 1.9% by weight of the overall steel (e.g., about 1.2% to about 1.8% by weight of the overall steel). It may include manganese in an amount of about 0.15% to about 1.8% by weight of the overall steel (e.g., about 0.25% to about 0.45% by weight of the overall steel). It may include silicon in an amount of about 0.1% to about 0.8% by weight of the overall steel (e.g., about 0.15% to about 0.35% by weight of the overall steel). Other elements may be employed as well, e.g., molybdenum in an amount below about 0.5% by weight of the overall steel, sulfur in an amount below about 0.03% by weight of the overall steel, and/or phosphorus in an amount below about 0.04% by weight of the overall steel.

Inspection of bearing components herein indicates that they may be characterized as including a plurality of stripes that are visible (e.g., via an optical microscope at a magnification of 100×). The stripes may have an appearance of being generally parallel. In a rolling bearing component, the stripes may be defined by a helical pattern. The spacing (W1) between the centerline of each successive stripe may be the same, or it may vary. Such spacing may range from about 50 to about 300 μm (e.g., about 100 to about 200 μm). There may be a region of overlap between successive stripes. The overlap region may have a width (W₂) of about 10 to about 70 μm, e.g., about 20 to about 70 μm.

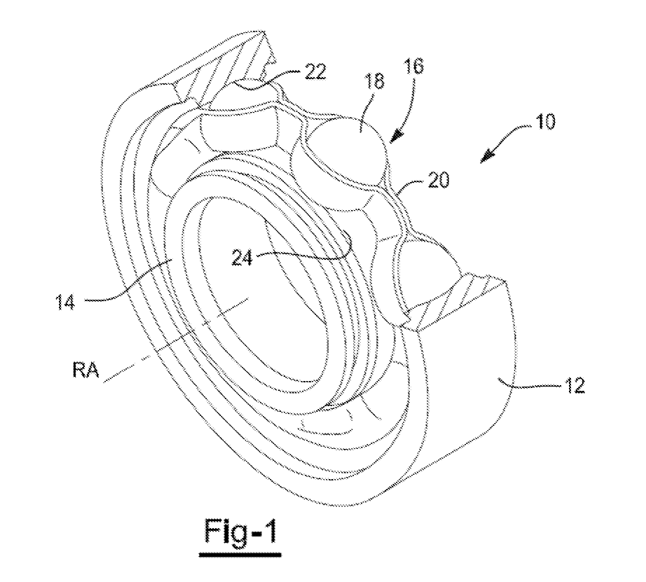

With reference to the drawings there is shown in FIG. 1, an illustrative bearing 10 that includes an outer ring 12, an inner ring 14, and a rolling body 16 that is depicted to include a plurality of balls 18 supported in a cage 20. The rotational axis is shown as RA. The outer ring 12 is shown to have an inner surface 22. An outer surface 24 of the inner ring 14 is also shown. The inner and outer surfaces have race surfaces defined to include a groove against which the rolling body can roll.

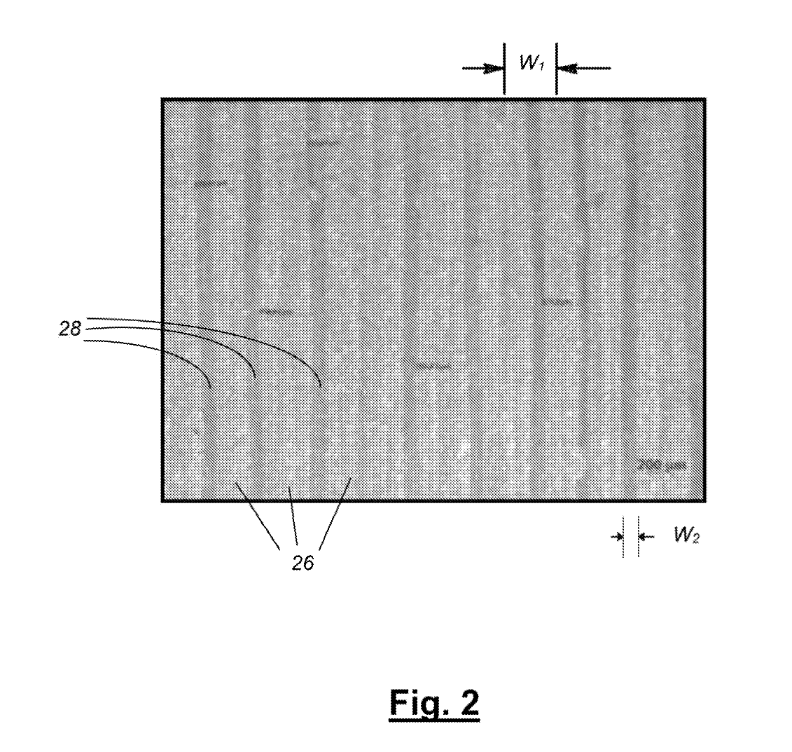

FIG. 2 illustrates a plurality of stripes 26 that are visible (e.g., via an optical microscope at a magnification of 20×). The stripes 26 have an appearance of being generally parallel, and the spacing between the centerline of each successive stripe is shown as W₁. In a rolling bearing component, the stripes may be defined by a helical pattern. A region of overlap 28 is defined between successive stripes, with a width W₂,

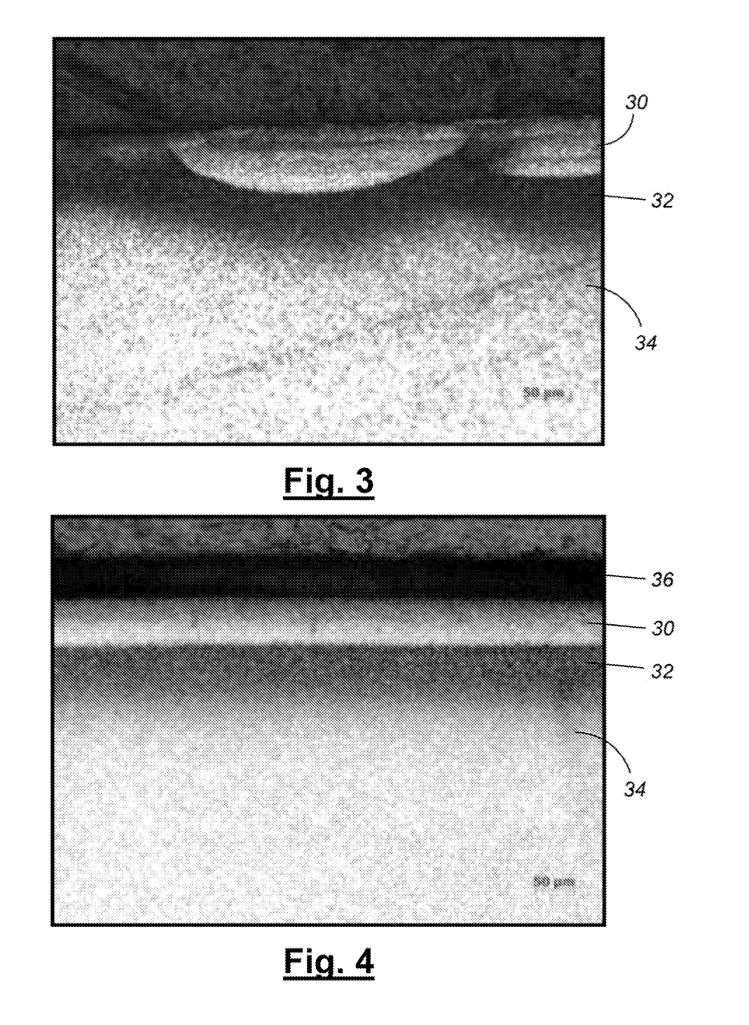

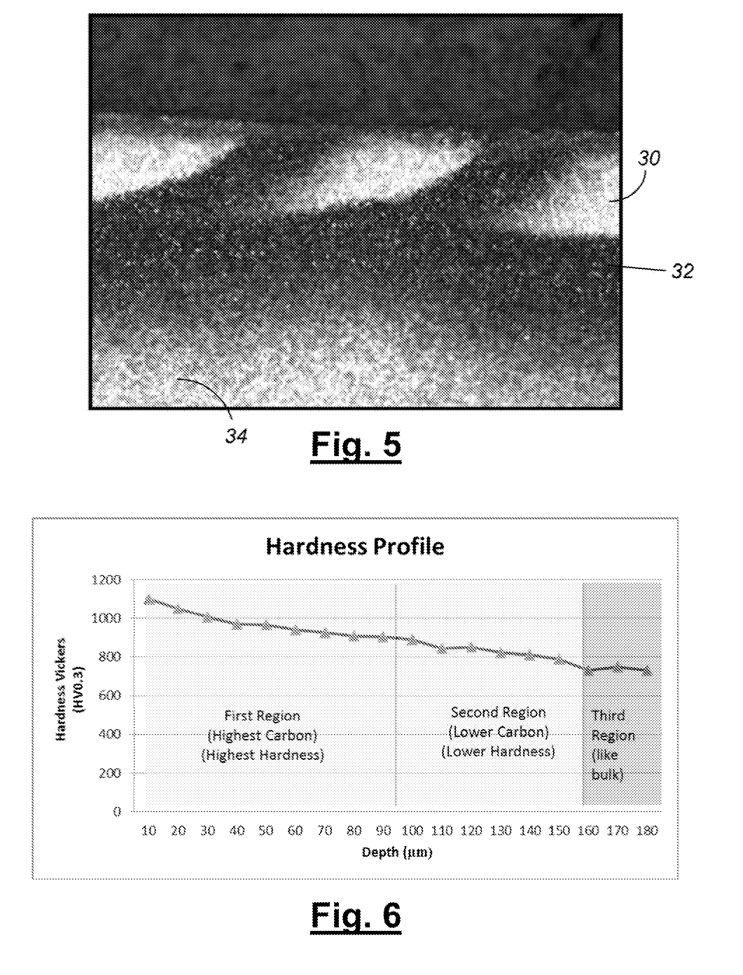

As seen in FIGS. 3 through 5, under a magnification of about 100× or higher, near the surface of the bearing component, there may be a lighter first region 30, which may have an arcuate shape in side section, a darker second region 32, and a lighter third region 34. A graphite layer 36 may overlie the exterior surface of the bearing component.

FIG. 6 illustrates an example of a hardness profile for one illustrative bearing component made of AISI 52100 steel and having a structure consistent with that shown in FIG. 4, with the first region in FIG. 6 corresponding to the first region 30 in FIG. 4, the second region in FIG. 6 corresponding with the second region 32 in FIG. 4, and the third region in FIG. 6 corresponding with the third region 34 in FIG. 4.

Without intending to be limited thereby, an example for how to prepare the bearing of the present teachings includes coating a bearing component (e.g., by spraying through a nozzle) with a carbon-containing composition to form a generally uniform thin film. The nozzle may be located at a distance of about 100 to about 500 mm from the bearing component surface (e.g., about 200 to about 400 mm, or even about 250 to about 300 mm). The bearing component and the nozzle may be rotated relative to each other at a rate of about 5 to about 50 rotations per minute, about 10 to about 30 rotations per minute (e.g., about 20 rotations per minute).

The coated component is then subject to a laser treatment by rotating the component and a laser relative to each other and progressively advancing the laser in a predetermined direction (e.g., in a path that is generally parallel with the rotational axis of the bearing component), The carbon-containing composition may include a plurality of ultrafine carbon-containing particles. It may also include at least one agent adapted for substantially uniformly dispersing the plurality of ultrafine carbon-containing particles in a liquid medium and for imparting sufficient viscosity to the liquid composition so that upon application of the liquid composition to the substrate, such as a bearing component, the liquid composition forms a generally homogeneous coating layer in contact with an external surface of the substrate, wherein the liquid composition is adapted for providing a source of carbon for diffusion into the substrate by application of laser induced energy.

By way of example, the exposed outer peripheral surface of an inner ring component and/or the exposed inner peripheral surface of an outer ring component may be coated with a liquid coating composition that includes a carbon-containing material, such as a plurality of ultrafine carbon-containing particles (e.g., natural graphite particles, synthetic graphite particles, carbon black, or any combination thereof) The median particle size of the carbon particles (per ASTM E11-01 or ISO 3310-1(2000)) will typically be below about 40 micrometers (μm), below about 25 μm, or even below about 10 μm. For example, the median particle size may be about 0.1 to about 40 μm, about 0.5 to about 25 μm, or even about 1 to about 10 μm (e.g, about 1, 3, 5, 7, or 9 μm). It is possible that the maximum particle size of at least 95% by weight may be below about 20 μm, 15 μm, or even 10 μm. The maximum particle size of about 50% by weight of the particles may be below about 10 μm, about 7 μm or even about 4 μm. The maximum particle size of about 10% by weight of the particles may be below about 4 μm, or even about 2 μm.

The liquid coating composition may also include at least one coating agent adapted for (i) substantially uniformly dispersing the plurality of ultrafine carbon-containing particles in a liquid medium (e.g., water, and/or an organic medium, such as an alcohol (e.g., methanol, ethanol, isopropanol, butanol or some other short-chain or medium chain alcohol), and/or a ketone (e.g., acetone)), and (ii) for imparting sufficient viscosity to the resulting liquid composition so that upon application of the liquid composition to the bearing component the liquid composition forms a generally homogeneous coating layer in contact with a coated surface of the bearing component, The at least one coating agent may include a water soluble protein (e.g., albumin), a material containing collagen or a derivative thereof (e.g., gelatin powder), bone marrow, a polysaccharide or a polysaccharide-containing material (e.g., a mixture of at least one glycoprotein and at least one polysaccharide), such as a material selected from wheat starch, potato starch, corn starch, tapioca, a dextrin (such as maltodextrin), carboxymethylcellulose (and/or a salt or another derivative thereof), gum Arabic. wheat flour, or any combination thereof. The at least one coating agent may include a combination of at least one protein and at least one polysaccharide. The at least one coating agent may include a combination of two, three, four or more polysaccharides. For example, when the at least one coating agent includes a starch, it may be in combination with another starch, and/or in combination with a dextrin, a carboxymethylcellulose (and/or a salt or another derivative thereof), and/or gum Arabic. For example, the coating agent may include a combination of two or more starches (e.g., two or more of wheat starch, potato starch, corn starch and or tapioca such as one including corn starch and wheat starch); a combination of wheat starch, potato starch, tapioca, and/or corn starch with a dextrin (e.g., maltodextrin) and a combination of a dextrin (e.g., maltodextrin) with carboxymethylcellulose (and/or a salt or another derivative thereof), or some other combination within the above teachings. Other examples of combinations that may be included in the coating agent include a combination of at least one starch (e.g., wheat starch, potato starch, rice starch, corn starch, and/or tapioca (or another starch having an amylose content (by weight) of at least about 10% dry basis, or about 20% dry basis (e.g., about 20 to about 35% dry basis of the starch)) mixed with carboxymethlcellulose (and/or a salt or another derivative thereof). For example, examples of a coating agent may include wheat starch with carboxymethylcellulose (and/or a salt or another derivative thereof), corn starch with carboxymethylcellulose (and/or a salt or another derivative thereof), or a combination of wheat starch and corn starch with carboxymethylcellulose (and/or a salt or another derivative thereof). The relative amounts of the two or more ingredients for the coating agent may be any suitable amount that achieves the desired characteristics. For example, in some applications, it is possible that approximately equal amounts by weight or volume of each coating agent ingredient may be employed. The at least one coating agent of the coating composition may be present in a weight ratio relative to the carbon-containing material (e.g., carbon-containing particles) of about 1:10 to about 1:1000 (e.g., about 1:50 to about 1:200, such as about 1:80, about 1:100, or about 1:120). The amount of carbon-containing material relative to the liquid medium (e.g., a short-chain alcohol, such as methanol, ethanol, and/or isopropanol) may range from about 0.5 to about 2 grams per about 50 milliliters (ml), about 0.5 to about 2 grams per about 20 ml or even about 0.5 to about 2 grams per about 10 ml (e.g., about 0.5 grams per about 10 ml, about 1 gram per about 10 ml, about 1.5 gram per about 10 ml, or about 2 grams per about 10 ml).

A suitable laser may be employed for controllably applying energy to the coated surface for causing diffusion of carbon into the mass of the bearing component from the surface and/or for forming a graphitic surface layer. For example, the teachings contemplate one or more steps such as employing a carbon dioxide (CO₂) laser; emitting a laser beam at a wavelength (λ) of about 10.6 μm at a power of about 50 watts (W) in a continuous mode operation; emitting a laser beam with a beam diameter of about 100 to about 200 μm (e.g., about 150 μm); operating the laser beam to emit a beam at a focal distance (defined as the distance from the closest surface of the focusing lens to the bearing component) of about 150 to about 200 mm (e.g., about 170 mm); operating the laser beam at a scan speed of about 50 to about 150 mm/second (e.g., about 100 mm/second); operating the laser beam at a fluency of about 4 to about 6×10⁶; operating the laser beam in a transverse electromagnetic (e.g., TEM-₀) mode of operation, by radio frequency and/or cooling the laser beam emitter with a fluid (e.g., water).

The laser treatment may occur while the bearing component is rotated about its rotational axis. For example, a ring of a roiling bearing may be located on an apparatus adapted for rotating the ring relative to a laser source. The apparatus may include a support housing structure. A rolling bearing carrier component may be employed having a longitudinal axis and a surface adapted to receive and engage at least one ring to be employed as part of a rolling bearing. A motor may be mounted to the support housing structure and coupled with the rolling bearing carrier, the motor being adapted for rotatably driving the carrier. A laser beam emitter may be adapted for emitting a laser beam that is aimed at an exposed surface of the ring. The carrier thus may be rotated while the at least one ring in generally opposing relationship with the beam of the laser beam emitter so that energy from the beam causes at least a portion of the coating on the ring to volatilize and be removed while also causing at least a portion of a carbon content of the carbon-containing coating to diffuse into the bearing, component.

In general, as to the teachings herein, the bearing components of the present teachings may be part of a bearing that may optionally be sealed. They may be part of a cylindrical rolling bearing, a spherical rolling bearing, a tapered roiling bearing, a needle rolling bearing, or some other rolling bearing.

The teachings herein contemplate that improved bearings can be realized in the absence of treating the bearings to impart a surface texture, the absence of impregnating a porous structure with a lubricant, the absence of sintering under high temperature and pressure, the absence of applying energy in an amount that causes the metal of the bearing to at least partially melt, the absence of any liquid phase arising during treatment, the absence of any quenching step, the absence of any post-laser treatment tempering step, or any combination thereof, the absence of a step of physical vapor deposition and/or chemical vapor deposition, the absence of a ceramic material layer, the absence of any diamond like carbon surface, the absence of any added metal layer, or any combination thereof.

In accordance with the present teachings it is thus seen how it may be possible to achieve a bearing component (e.g., an inner and/or outer ring of a rolling bearing) having relatively hard surface that is free of surface ablation or fusion, and which may have a resulting coefficient of friction that is reduced by at least about one third, one half, or two thirds of its initial coefficient of friction prior to the treatment according to the present teachings. The surface hardness may be increased at least about 10%, 20%, 30%, or higher relative to the initial surface hardness prior to the treatment according to the present teachings,

Chemical analysis of materials can be performed using energy-dispersive X-ray spectroscopy. Metallographic inspection may employ conventional sectioning, mounting, grinding, polishing and etching (e.g., with 2% Picral etch) for revealing microstructure through an optical microscope, or by way of visual inspection (e.g., for revealing a boundary between the first and the second regions). Optionally, inspection may be made using a scanning electron microscope (e.g., for analyzing the morphology of a resulting layer of graphite deposited onto a surface).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80 more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight, and vice versa. Thus, an expression in the Detailed Description of the Invention of a range in terms of at “‘x’ parts by weight of the resulting composition” also contemplates a teaching of ranges of same recited amount of “x” in percent by weight of the resulting composition. Relative proportions derivable by comparing relative parts or percentages are also within the teachings, even if not expressly recited.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consisting of, the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

Relative positional relationships of elements depicted in the drawings are part of the teachings herein, even if not verbally described. Further, geometries shown in the drawings (though not intended to be limiting) are also within the scope of the teachings, even if not verbally described.

1. A bearing component, comprising:
a. a peripheral surface adapted for contacting a rolling body and having an in situ formed layer of graphite at least partially covering the peripheral surface;
b. a mass terminating at the peripheral surface;
wherein the peripheral surface is characterized by a plurality of visible overlapping striped regions that is generally devoid of any surface erosion;
wherein the mass includes a first region having a depth and having a first carbon content;
wherein the mass includes a second region beneath and generally directly adjoining the first region having a depth and having a second carbon content that is less than the first carbon content of the first region;
wherein the mass includes a third region beneath and generally directly adjoining the second region having a third carbon content that is less than the first and second carbon content of the first and the second region;
wherein progressing from the peripheral surface to the third region there is a generally continuous decrease in the amount of carbon and hardness, until a generally constant amount of carbon and hardness is realized in the third region.

2. The bearing component of claim 1, wherein the peripheral surface is configured as a rolling surface of an outer bearing ring, or a rolling surface of an inner bearing ring.

3. The bearing component of claim 1, wherein the rolling body includes a ball, a cylinder or a pin.

4. The bearing component of claim 1, wherein the bearing component is generally annular.

5. The bearing component of claim 1, wherein the peripheral surface includes a layer of graphite at least partially coated thereon to a thickness of about 0.3 μm.

6. The bearing component of claim 1, wherein the plurality of visible overlapping striped regions include at least one helical stripe having a generally continuous width that circumscribes the bearing component and overlaps an adjoining stripe in an amount of about 5 to about 80 percent of the width of the adjoining stripe.

7. The bearing component of claim 1, wherein the plurality of visible overlapping striped regions include at least one helical stripe and the at least one helical stripe has a width in the range of about 100 to about 500 micrometers.

8. The bearing component of claim 1, wherein the first region has a hardness in the range of about 850 to about 1150 HV_{0.3}, and the hardness decreases moving away from the peripheral surface toward the second region.

9. The bearing component of claim 1, wherein the second region has a hardness in the range of about 700 to about 850 HV_{0.3}; and the hardness decreases moving away from the first region toward the third region.

10. The bearing component of claim 1, wherein the third region has a hardness that is generally constant and in the range of about 560 to about 700 HV_{0.3}.

11. The bearing component of claim 1, wherein the third region is a steel that has a composition that includes carbon in an amount of about 0.7 to about 12% by weight of the overall steel of the third region, chromium in an amount of about 0.8 to about 1.9% by weight of the overall steel of the third region, manganese in an amount of about 0.15 to about 1.8% by weight of the overall steel of the third region; and silicon in an amount of about 0.1 to about 0.8% by weight of the overall steel of the third region.

12. The bearing component of claim 1, wherein the first region is distinguishable from the second region by a visible color change upon etching, and/or wherein the third region is distinguishable from the second region and the first region by a presence in the third region of a generally constant hardness, and a generally constant carbon content.

13. The bearing component of claim 1, wherein the depth of the first region is about 50 to about 200 micrometers.

14. The bearing component of claim 1, wherein the depth of the second region is about 50 to about 100 micrometers.

15. A bearing including a bearing component of claim 1.

16. (canceled)

17. (canceled)

18. The bearing component of claim 2, wherein the peripheral surface includes a layer of graphite at least partially coated thereon to a thickness of about 0.3 μm.

19. The bearing component of claim 2, wherein the first region has a hardness in the range of about 850 to about 1150 HV_{0.3}, and the hardness decreases moving away from the peripheral surface toward the second region.

20. The bearing component of claim 19, wherein the second region has a hardness in the range of about 700 to about 850 HV_{0.3}, and the hardness decreases moving away from the first region toward the third region.

21. The bearing component of claim 20, wherein the third region has a hardness that is generally constant and in the range of about 560 to about 700 HV_{0.3}.

22. The bearing component of claim 2, wherein the first region is distinguishable from the second region by a visible color change upon etching, and/or wherein the third region is distinguishable from the second region and the first region by a presence in the third region of a generally constant hardness, and a generally constant carbon content.
